(19) United States
(12) Patent Application Publication
(10) Pub. No.: US 2026/0171667 A1
(43) Pub. Date: Jun. 18, 2026

(54) APPARATUS HAVING ANTENNA ARRAYS

(71) Applicant: Nokia Solutions and Networks Oy, Espoo (FI)

(72) Inventors: Andrei MALKOV, Espoo (FI); Olli Pekka KOISTINEN, Espoo (FI)

(21) Appl. No.: 19/419,467

(22) Filed: Dec. 15, 2025

(30) Foreign Application Priority Data
Dec. 18, 2024 (FI) 20246486

(51) Int. Cl. H01Q 5/30; H01Q 1/52

(52) U.S. Cl. CPC H01Q 5/30; H01Q 1/523; H01Q 1/526

(57) ABSTRACT

An apparatus, comprising: a first antenna array comprising a plurality of first antenna array elements configured to transmit signals comprising encoded data in a first frequency band; a second antenna array comprising a plurality of second antenna array elements configured to receive signals comprising encoded data in the first frequency band; a third antenna array comprising a plurality of third antenna array elements; a suppression signal generator configured to generate first suppression drive signals in the first frequency band for the third antenna array elements to generate a compensating electromagnetic field to reduce interference received by the plurality of second antenna array elements in the first frequency band from the plurality of first antenna array elements; and a transceiver coupled with the third antenna array and configured to convey signals comprising encoded data in a second frequency band, wherein the second frequency band differs from the first frequency band.

### TECHNOLOGICAL FIELD

Various example embodiments relate to an apparatus having antenna arrays.

### BACKGROUND

Apparatus having antenna arrays for use in, for example, a wireless telecommunications network are known. Although such apparatus exist, they can have shortcomings. Accordingly, it is desired to provide an improved apparatus.

### BRIEF SUMMARY

The scope of protection sought for various example embodiments of the invention is set out by the independent claims. The example embodiments and features, if any, described in this specification that do not fall under the scope of the independent claims are to be interpreted as examples useful for understanding various embodiments of the invention.

According to various, but not necessarily all, example embodiments of the invention there is provided an apparatus, comprising: a first antenna array comprising a plurality of first antenna array elements configured to transmit signals comprising encoded data in a first frequency band; a second antenna array comprising a plurality of second antenna array elements configured to receive signals comprising encoded data in the first frequency band; a third antenna array comprising a plurality of third antenna array elements; a suppression signal generator configured to generate first suppression drive signals in the first frequency band for the third antenna array elements to generate a compensating electromagnetic field to reduce interference received by the plurality of second antenna array elements in the first frequency band from the plurality of first antenna array elements; and a transceiver coupled with the third antenna array and configured to convey signals comprising encoded data in a second frequency band, wherein the second frequency band differs from the first frequency band.

According to various, but not necessarily all, example embodiments of the invention there is provided a method comprising: transmitting signals comprising encoded data in a first frequency band with a first antenna array comprising a plurality of first antenna array elements; receiving signals comprising encoded data in the first frequency band with a second antenna array comprising a plurality of second antenna array elements; generating first suppression drive signals in the first frequency band for a third antenna array comprising a plurality of third antenna array elements to generate a compensating electromagnetic field to reduce interference received by the plurality of second antenna array elements in the first frequency band from the plurality of first antenna array elements; and conveying signals comprising encoded data in a second frequency band with the third antenna array, wherein the second frequency band differs from the first frequency band.

According to various, but not necessarily all, example embodiments of the invention there is provided a computer program comprising instructions stored thereon for performing at least the following: transmitting signals comprising encoded data in a first frequency band with a first antenna array comprising a plurality of first antenna array elements; receiving signals comprising encoded data in the first frequency band with a second antenna array comprising a plurality of second antenna array elements; generating first suppression drive signals in the first frequency band for a third antenna array comprising a plurality of third antenna array elements to generate a compensating electromagnetic field to reduce interference received by the plurality of second antenna array elements in the first frequency band from the plurality of first antenna array elements; and conveying signals comprising encoded data in a second frequency band with the third antenna array, wherein the second frequency band differs from the first frequency band.

According to various, but not necessarily all, example embodiments of the invention there is provided a non-transitory computer readable medium comprising program instructions stored thereon for performing at least the following: transmitting signals comprising encoded data in a first frequency band with a first antenna array comprising a plurality of first antenna array elements; receiving signals comprising encoded data in the first frequency band with a second antenna array comprising a plurality of second antenna array elements; generating first suppression drive signals in the first frequency band for a third antenna array comprising a plurality of third antenna array elements to generate a compensating electromagnetic field to reduce interference received by the plurality of second antenna array elements in the first frequency band from the plurality of first antenna array elements; and conveying signals comprising encoded data in a second frequency band with the third antenna array, wherein the second frequency band differs from the first frequency band.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION

Some example embodiments will now be described with reference to the accompanying drawings in which:

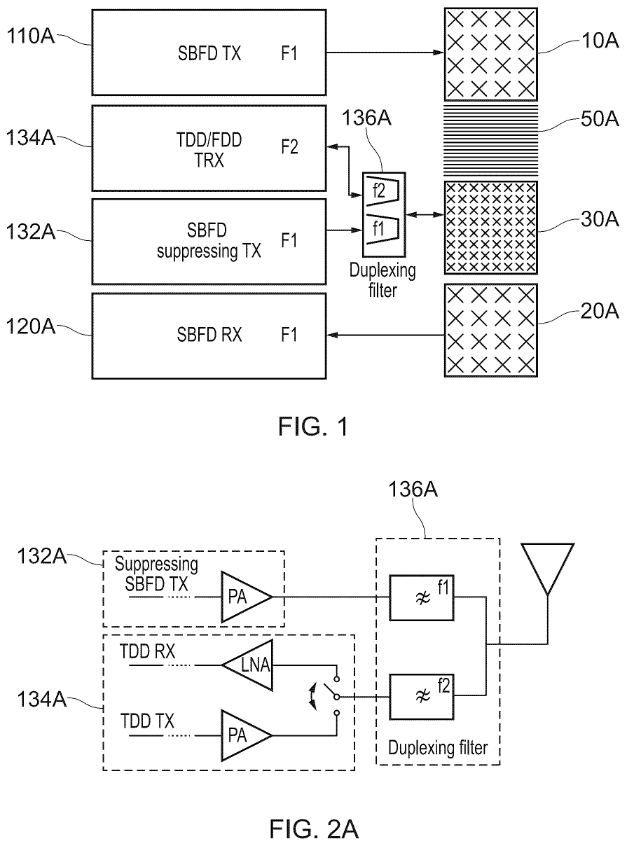

FIG. 1 illustrates a first antenna configuration according to one example embodiment;

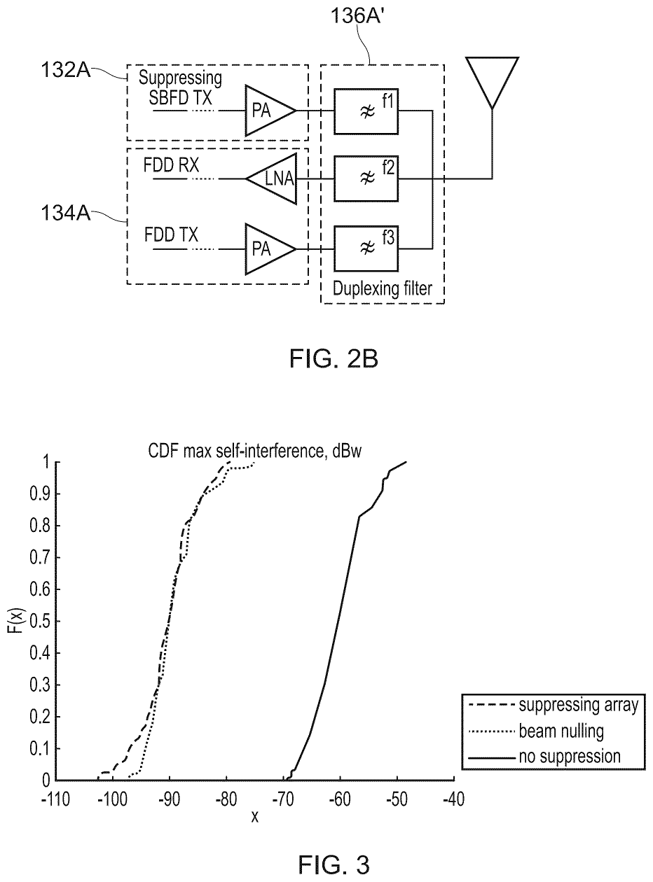

FIG. 2A shows one part of the radio-frequency (RF) chain, connected to one antenna array element of the third antenna array according to one example embodiment;

FIG. 2B shows one part of the RF chain, connected to one antenna array element of the third antenna array according to one example embodiment;

FIG. 3 shows the interference power at the most affected antenna element for the first antenna configuration;

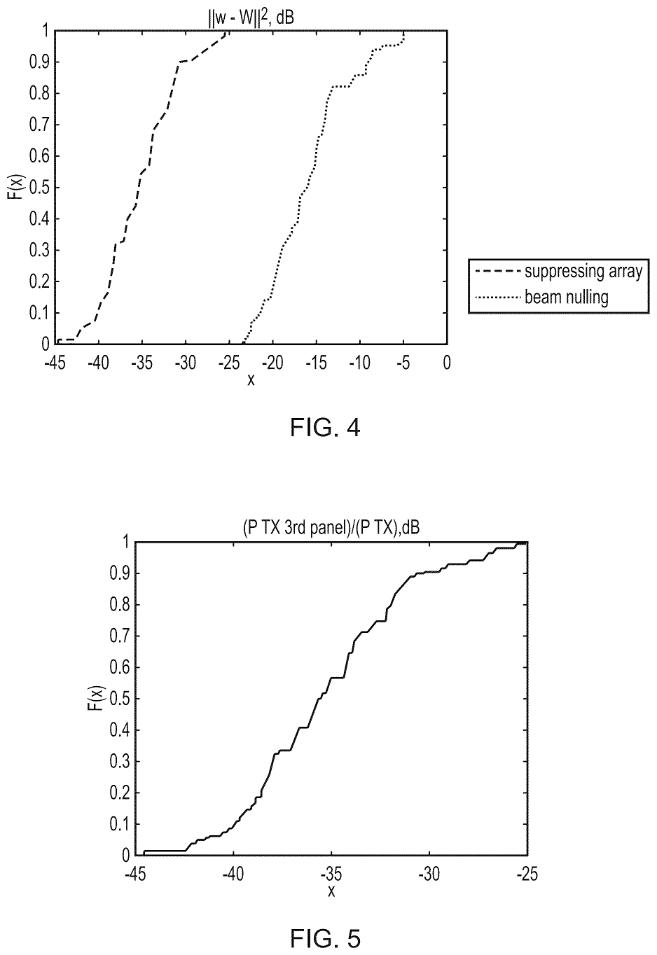

FIG. 4 shows the distortion of the beamforming vector for the Method 2 (suppressing array) and beam nulling for the first antenna configuration;

FIG. 5 shows the ratio of the suppressing array power (power needed for self-interference suppression) to the TX (Transmit) f1 array power for the first antenna configuration;

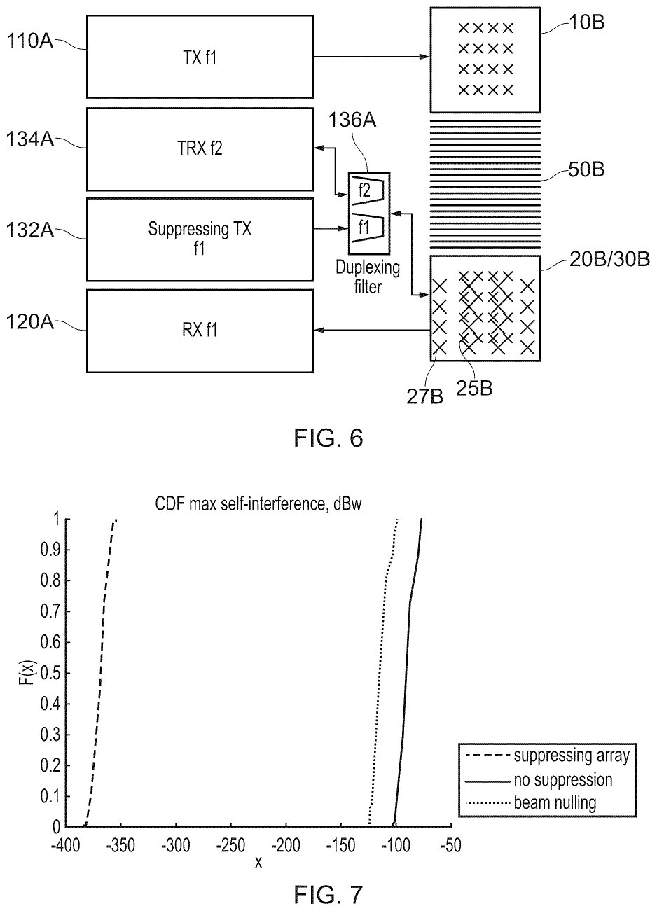

FIG. 6 illustrates a second antenna configuration according to one example embodiment;

FIG. 7 shows the interference power at the most affected antenna element for the second antenna configuration;

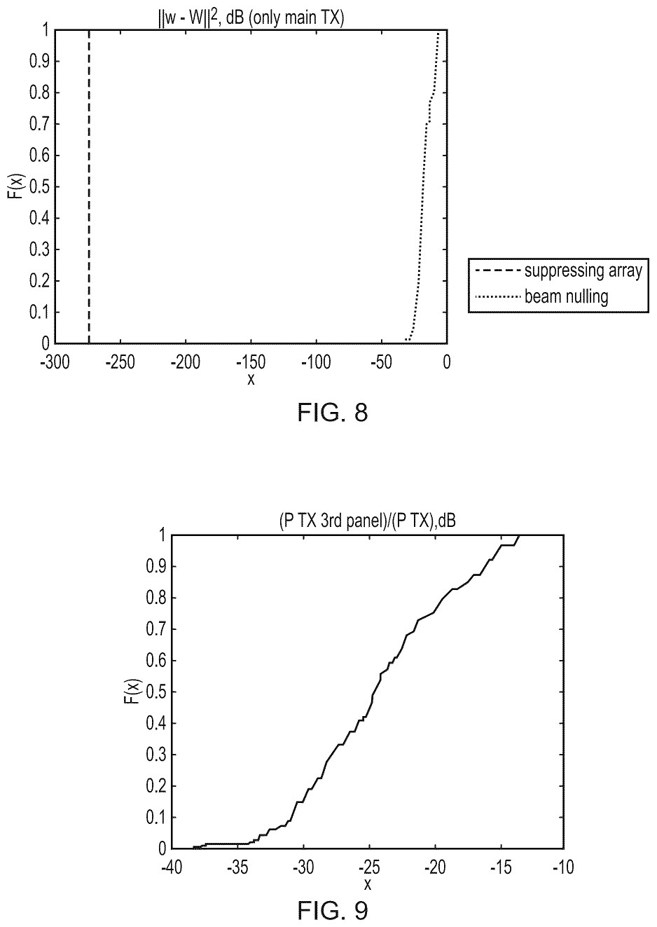

FIG. 8 shows the distortion of the beamforming vector for the second antenna configuration;

FIG. 9 shows the relative power, radiated by the suppressing array, for the second antenna configuration;

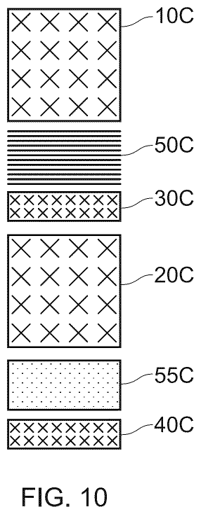

FIG. 10 illustrates a third antenna configuration according to one example embodiment;

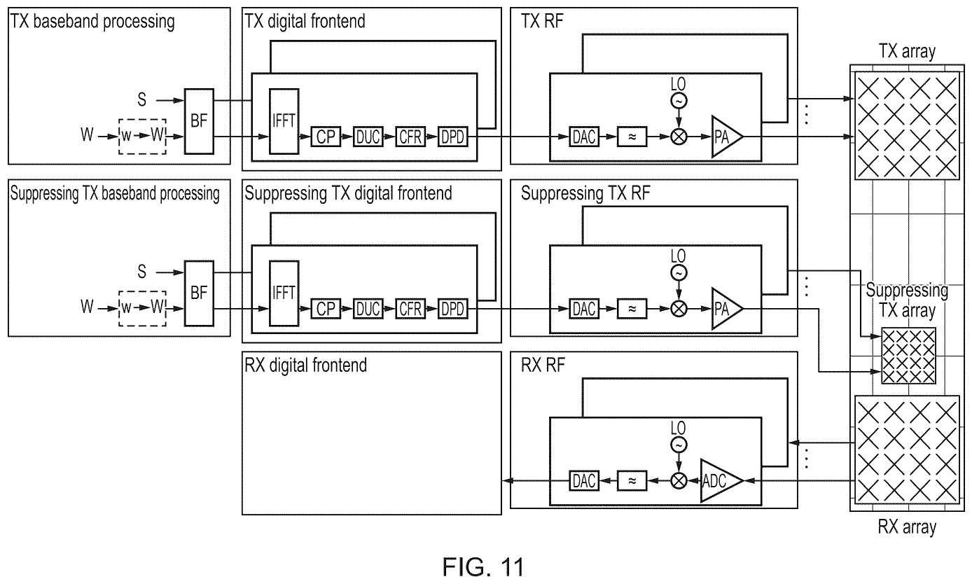

FIG. 11 illustrates schematically a front end for driving the antenna according to one example embodiment;

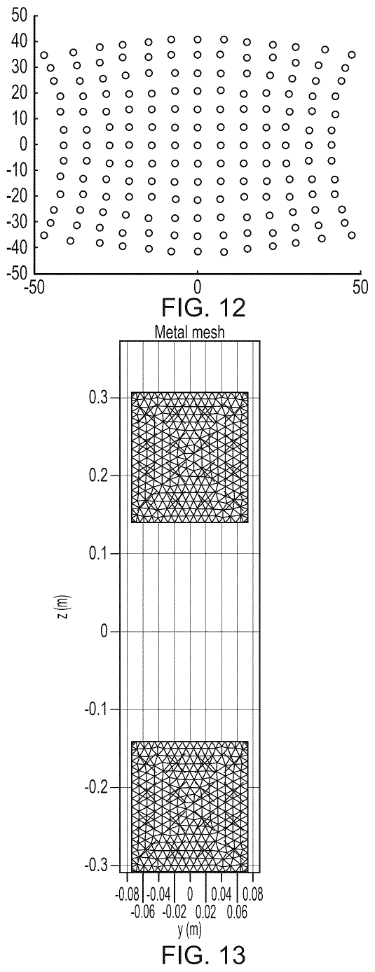

FIG. 12 illustrates azimuth and elevation angle for 169 beamforming vectors used in simulations;

FIG. 13 illustrates an example of meshing used by a method of moments (MoM) solver;

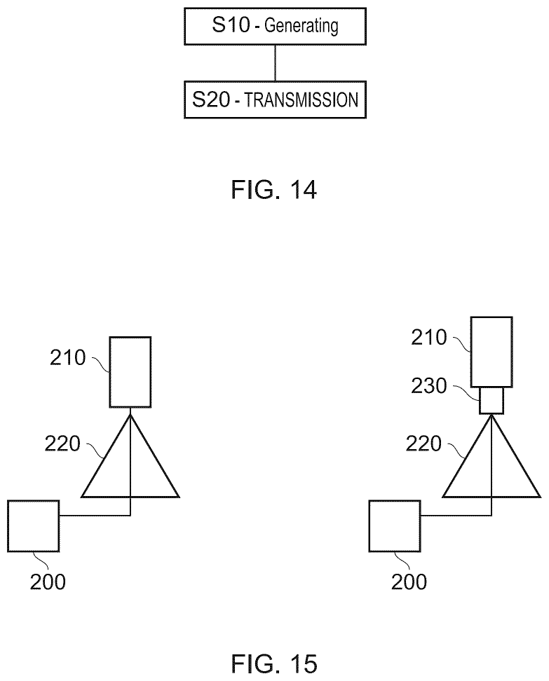

FIG. 14 is a flowchart illustrating a method according to one example embodiment; and

FIG. 15 illustrates example arrangements of the antenna configurations.

### DETAILED DESCRIPTION

Before discussing the example embodiments in any more detail, first an overview will be provided. Some example embodiments provide an arrangement where an antenna array is used to for a dual purpose. First, the antenna array is used to provide suppression signals (reduction of interference) in a first frequency band to suppress interference signals received by a reception chain of another antenna array caused by transmissions from a further antenna array. The antenna array is then reused for transmission and/or reception of signals in a second frequency band. This allows for the reuse of that antenna array to support communication on the second frequency band, thereby providing for a compact and efficient antenna arrangement. The antenna array may be separate or collocated with an antenna array receiving the signals in the first frequency band. Further suppression arrays and further transmission arrays may be provided to support suppression and transmission and/or reception in further frequency bands.

### Sub-Band Non-Overlapping Full Duplex

Sub-band non-overlapping full duplex (SBFD) was a study item of 3GPP Rel.18. Normative work has been started in Rel.19. SBFD is a duplexing scheme, which is based on time-division duplexing (TDD). In a TDD time slot (or part of the slot), transmission is allowed only in a downlink (DL) or an uplink (UL) direction. In an SBFD time slot, transmission is allowed in both directions. Like TDD, SBFD uses one frequency channel. UL and DL transmission occurs on two or more temporarily or permanently allocated frequency subchannels. The main motivation for introducing SBFD is to improve coverage and to reduce latency. The coverage improvement is expected because the user equipment (UE) has more uplink transmission opportunities (in terms of time) and therefore can use more energy for uplink transmission. Latency improvement is expected because UL transmission opportunities occur more frequently.

Base station (gNB) or other network node self-interference can be problematic for SBFD, creating challenges for SBFD implementation. To make UL reception possible, the gNB receiver should be protected (isolated) from the gNB's own transmission in DL.

To help with self-interference in SBFD, transmit (TX) and receive (RX) antenna arrays are typically implemented as two separate entities. The spatial separation between these two arrays provides so-called spatial isolation. The further away the TX and RX arrays are from each other, the higher the isolation. However, starting from approximately 1.5λ of the array-to-array distance, the isolation level increases slowly reaching approximately 40 dB of element-to-element isolation at 4λ, where λ is a wavelength. This is far from the desired level of isolation. To provide additional TX-RX isolation, a shield, wave trap or similar structures sometimes referred to as passive antenna array can be included. However, a base station or other network node may support more than one frequency band and this may require adding yet another antenna array to already bulky antenna setup. Self-Interference Cancellation (SIC) techniques may further be utilised to further enhance the overall system isolation requirement.

### Self-Interference Suppression

Some example embodiments provide for an antenna configuration for a dual (or multi) band base station (or other network node) supporting SBFD. The same antenna array is used for data transmission and/or reception at one frequency band and for self-interference suppression at another frequency band.

### Configuration 1

This example embodiment has three active antenna arrays and one optional passive antenna array, as shown in FIG. 1. A first antenna array 10A having a plurality of antenna elements is connected to transmit (TX) block 110A and performs data transmission of encoded data at frequency band f1. A second antenna array 20A having a plurality of antenna elements is connected to receive (RX) block 120A and performs data reception of encoded data at frequency band f1. A third antenna array 30A having a plurality of antenna elements is connected to TX block 132A and performs self-interference suppression at frequency band f1 by generating suppression drive signals for transmission by the third antenna array 30A. Hence, the third antenna array 30A acts as a suppressing antenna array. One purpose of the suppressing antenna array is to generate an electromagnetic field such that its superposition with an electromagnetic field generated by the first antenna array 10A reduces self-interference at each RX antenna array element of the second antenna array 20A. The ‘shape’ of the electromagnetic field, generated by the first antenna array 10A, depends on the beamforming vector applied to this antenna array and therefore the electromagnetic field, generated by the suppressing antenna array should be changed accordingly. This is achieved by applying weight vector to the suppressing antenna array, calculated based on the beamforming vector of the first antenna array 10A. The suppressing antenna array is designed in a way to make radiated power, required for suppression, many times lower than the radiated power of the first antenna array 10A. This radiated power can be further reduced by increasing isolation between the first antenna array 10A (the TX array) and the second antenna array (the RX array). This can be done, for example, by locating a passive suppressing antenna array 50A between the TX antenna array and the suppressing antenna array. The third antenna array 30A is connected to transceiver (TRX) block 134A and also performs data transmission of encoded data and data reception of encoded data at frequency band f2. A duplexing filter 136A is provided between the third antenna array 30A and the TRX block 134A and the TX block 132A. Typically, the passive antenna array 50A is used for SBFD self-interference suppression in frequency band f1. Typically, a radio frequency (RF) filter (not shown) is provided between the second antenna array 20A and the RX block 120A which performs filtering to reduce received out-of-band interference at the frequency band f1, such as interference caused by signals within the frequency band f2. Typically, an RF filter (not shown) is provided between the first antenna array 10A and the TX block 110A which performs filtering to reduce out-of-band spurious emissions of its power amplifier (PA) (not shown). Given that this arrangement uses the suppressing array concurrently for self-interference suppression at frequency band f1 and for transmission and reception at frequency band f2, the antenna elements and inter element spacing are two times smaller (half the size) of that of the TX and RX arrays, as it would be optimized for the frequency f2=2f1. In another example implementation the suppressing antenna array can be optimized for a different frequency band with a different f1/f2 ratio. Hence, there is provided an antenna configuration which performs SBFD transmission and reception in frequency band f1 and performs self-interference suppression at frequency band f1. The third antenna array 30A when performing self-interference suppression at frequency band f1 is reused to perform TDD transmission and reception in frequency band f2 or FDD transmission in frequency band f3 and reception in frequency band f2. In other words, the first antenna array 10A is dedicated to SBFD TX. The passive antenna array 50A is dedicated to suppressing self-interference caused by SBFD TX signals arriving at the SBFD RX chain 120A. The third antenna array 30A is dedicated to SBFD self-interference suppression at frequency band f1 and for a TDD carrier at frequency band f2 or for FDD carrier at frequency band f2 and f3. The second antenna array 20A is dedicated to SBFD RX.

In one example embodiment, the SBFD carrier is allocated in the frequency band f1 and the TDD carrier in the frequency band f2. The first antenna array 10A and the second antenna array 20A are used for SBFD TX and RX, respectively. Passive antenna array 50A is used for SBFD self-interference suppression. The third antenna array 30A is used for SBFD self-interference suppression and for TDD transmission and reception. The third antenna array 30A is connected to the TRX block 134A and to the suppressing TX block 132A using duplexing filter 136A.

In one example implementation, the SBFD carrier is allocated in the frequency band f1 and the FDD carrier in the frequency band f2 (FDD RX) and f3 (FDD TX). The first antenna array 10A and the second antenna array 20A are used for SBFD TX and RX, respectively. Passive antenna array 50A is used for SBFD self-interference suppression. The third antenna array 30A is used for SBFD self-interference suppression and for FDD transmission and reception.

FIG. 2A shows one part of the RF chain including parts of the TRX block 134A, the suppressing TX block 132A and duplexing filter 136A, connected to one antenna array element of the third antenna array 30A for the f1 SBFD/f2 TDD implementation. The duplexing filter 136A functionally has two band-pass filters, one tuned to frequency f1, the other to frequency f2. Pass band filter f1 is connected to the power amplifier (PA) of the suppressing TX block 132A. Pass band filter f2 is connected through a switch to the low noise amplifier (LNA) or to the PA of the TDD TRX chain of the TRX block 134A.

FIG. 2B shows one part of the RF chain including parts of the TRX block 134A, the suppressing TX block 132A and a duplexing filter 136A′, connected to one antenna array element of the third antenna array 30A for the f1 SBFD/f2&f3 FDD implementation. The duplexing filter 136A′ functionally has three pass band filters, tuned to frequency f1, f2 and f3. Pass band filter f1 is connected to the PA of the suppressing TX block 132A. Pass band filter f2 is connected to the LNA of the FDD carrier RX. Pass band filter f3 is connected to the PA of the FDD carrier TX.

As mentioned above, self-interference suppression in example embodiments is achieved by applying a weight vector to the suppressing antenna array and by modifying the beamforming vector. Any method of the weight vector calculation while providing self-interference suppression should seek to modify beamforming vector as little as possible. Another optimization criterium is suppressing array radiated power (radiated power required for self-interference suppression excluding the radiated power at f2), which should be minimized as well.

Two main methods for calculating this weight vector are provided, as set out in more detail below. Method 1, is based on the covariance matrix of the interference channel between the suppressing antenna array and the RX antenna array and on the covariance matrix of the interference channel between the TX antenna array and the RX antenna array. This method calculates the weight vector, which when applied to the suppressing antenna array, causes it to generate an electro-magnetic (EM)-field, which when superimposed with EM-field generated by the TX antenna array, reduces self-interference at the RX antenna array elements. Method 2 is based on the covariance matrix of the channel between the suppressing antenna array and the RX antenna array and between the TX antenna array and the RX antenna array. This method calculates the weight vector and the beamforming vector. When these vectors are applied correspondingly to the suppressing antenna array and to the TX antenna array, the superposition of the generated EM-fields results in reduced self-interference at the RX antenna array elements.

Antenna configuration 1 was simulated for the case when f2>f1. For example, the SBFD carrier may be allocated at FR3 and the TDD carrier at FR2. In this example embodiment, the third antenna array 30A has approximately the same size as the first antenna array 10A and second antenna array 20A and it contains twice as many antenna array elements as they do. The first antenna array 10A and the second antenna array 20A have 32 cross-polarized antenna array elements each. The distance between those arrays is 4λ, where λ is a wavelength. The third antenna array 30A has 64 cross-polarized antenna array elements. The length of each dipole, as well as the horizontal and vertical spacing between elements, is half that of the first antenna array 10A and second array 20A, and is equal to 0.25λ. The passive antenna array 50A is located between the first antenna array 10A and the third antenna array 30A. In simulations it is assumed that it provides 10 dB of the additional isolation. In this example, the third (suppressing) antenna array 30A is located away from the second (RX f1) antenna array 20A. This limits which beamforming vector calculation method can be used. Method 1 may not be practical in this case because when applied to antenna configuration 1, even though it completely eliminates self-interference, the power required for suppression becomes very high. Method 2 guarantees that the power required for suppression is not too high, as shown in FIG. 5. In the worst case (for the most interfering beam), that power is 25 dB lower than the power of the first antenna array 10A. Method 2 and a “traditional” beam nulling technique provide very similar levels of self-interference suppression, see FIG. 3. An advantage of this approach is that it provides almost 20 dB less distortion of the beamforming vector than the “traditional” beam nulling, see FIG. 4. The distortion of the beamforming vector, shown in FIG. 4, was calculated according to equation (16) for beam nulling and according to equation (17) for the suppressing array set out below.

### Configuration 2

This example embodiment has three active antenna arrays and one optional passive antenna array, as shown in FIG. 6. The arrangement and operation of this configuration is similar to that set out above in configuration 1 except that the second and third antenna array are collocated and the frequency band f2 is lower than the frequency band f1. A first antenna array 10B having antenna elements is connected to TX block 110A and performs data transmission of encoded data at frequency band f1. A combined (co-located) second and third antenna array 20B/30B having RX antenna elements 25B is connected to RX block 120A and performs data reception of encoded data at frequency band f1. The combined (co-located) second and third antenna array 20B/30B has other antenna elements 27B connected to TX block 132A and performs self-interference suppression at frequency band f1 by generating suppression drive signals for transmission by those antenna elements. Hence, antenna elements 27B act as a suppressing antenna array. One purpose of suppressing antenna array is to generate electromagnetic field such that its superposition with an electromagnetic field generated by the first antenna array 10B reduces self-interference at each RX antenna array element 25B. The ‘shape’ of the electromagnetic field, generated by the first antenna array 10B, depends on the beamforming vector applied to this antenna array and therefore the electromagnetic field, generated by the suppressing antenna array should be changed accordingly. This is achieved by applying weight vector to the suppressing antenna array, calculated based on the beamforming vector of the first antenna array 10B. The suppressing antenna array is designed in a way to make radiated power, required for suppression, many times lower than the radiated power of the first antenna array 10B. This radiated power can be further reduced by increasing isolation between the first antenna array 10B (the TX array) and RX antenna elements 25B (the RX array). This can be done, for example, by locating a passive suppressing antenna array 50B between the TX antenna array and the suppressing antenna array. The antenna elements 27B are also connected to TRX block 134A and perform data transmission of encoded data and data reception of encoded data at frequency band f2. The duplexing filter 136A is provided between the antenna elements 27B and the TRX block 134A and the TX block 132A. Typically, the passive antenna array 50B is used for SBFD self-interference suppression in frequency band f1. Typically, a filter (not shown) is provided between antenna elements 25B and the RX block 120A which performs filtering to reduce received out-of-band interference at the frequency band f1, such as interference caused by signals within the frequency band f2. Typically, an RF filter (not shown) is provided between the first antenna array 10B and the TX block 110A which performs filtering to reduce out-of-band spurious emissions of its power amplifier (PA) (not shown). Given that this arrangement uses the suppressing array concurrently for self-interference suppression at frequency band f1 and for transmission and reception at frequency band f2, the antenna elements 27B and inter element spacing are two times larger (twice the size) of that of the TX and RX arrays, as it would be optimized for the frequency f2=f1/2. In another example implementation the suppressing antenna array can be optimized for a different frequency band with a different f1/f2 ratio.

Antenna configuration 2 was simulated for the case when f2<f1. For example, the SBFD carrier can be allocated at FR3 and the FDD/TDD carrier can be allocated at FR1. The first antenna array 10B and the RX antenna elements 25B of the combined (co-located) second and third antenna array 20B/30B may be 32 cross-polarized antenna array elements each. The length of each dipole is 0.5λ, where λ, where λ is a wavelength corresponding to f1. The horizontal and vertical spacing between antenna array elements is correspondingly 0.5λ and 0.7λ. The distance between the first antenna array 10B and the combined (co-located) second and third antenna array 20B/30B is 4λ. The number of antenna elements in the first antenna array is the same as the number of RX antenna elements 25B and the number of antenna elements 27B. The suppressing antenna array elements 27B are interlaced with the antenna array elements 25B. The length of each dipole is 0.75λ. The horizontal and vertical spacing between antenna array elements 27B is correspondingly 1.0λ and 0.7λ. The passive antenna array 50B is located between the first antenna array 10B and the combined (co-located) second and third antenna array 20B/30B. In simulations, it is assumed that it provides 10 dB of the additional isolation.

In this example, the suppressing antenna array elements 27B are located much closer to the RX f1 antenna array elements 25B. This eases restrictions on the beamforming vector calculation method and, unlike antenna configuration 1, method 1 is more practical for use with antenna configuration 2. Method 1 completely eliminates self-interference, see ‘suppressing array’ curve on FIG. 7 (TX noise was ignored in simulations), causing no distortion of the TX beam of the first antenna array 10B (see FIG. 8). The power used for suppression is in the worst case (for the most interfering beam) 14 dB lower than the power of the first antenna array 10B, see FIG. 9.

### Configuration 3

This example embodiment has four active antenna arrays and two optional passive antenna arrays, as shown in FIG. 10. The arrangement and operation of this configuration is similar to that set out above in configuration 1 except that a third antenna array 30C performs suppression at f1 and reception at f2, a second antenna array 20C performs suppression at f2 and reception at f1, and a fourth antenna array 40C is provided which performs transmission at f2. Hence, two separate suppression drive signals are generated, one for the third antenna array 30C at f1 and one for the second antenna array 20C at f2. A first passive suppressing antenna array 50C for suppressing at f1 is located between the first antenna array 10C and the third antenna array 30C. A second passive suppressing antenna array 55C for suppressing at f2 is located between the fourth antenna array 40C and the second antenna array 20C.

A first antenna array 10C having antenna elements is connected to a TX block and performs data transmission of encoded data at frequency band f1. The second antenna array 20C having antenna elements is connected to an RX block and performs data reception of encoded data at frequency band f1. The second antenna array 20C is also connected to a TX block and performs self-interference suppression at frequency band f2 by generating suppression drive signals for transmission by the second antenna array 20C. Hence, the second antenna array 20C acts as a suppressing antenna array, suppressing signals transmitted by the fourth antenna array 40C. The fourth antenna array 40C having a plurality of antenna elements is connected to a TX block and performs data transmission of encoded data at frequency band f2. The third antenna array 30C having antenna elements is connected to an RX block and performs data reception of encoded data at frequency band f2. The third antenna array 30C is also connected to a TX block and performs self-interference suppression at frequency band f1 by generating suppression drive signals for transmission by the third antenna array 30C. Hence, the third antenna array 30C acts as a suppressing antenna array, suppressing signals transmitted by the first antenna array 10C.

### Suppressing Antenna Array—Signal Generation

The suppressing antenna array is connected to the analog and digital chain, similar to that of the (main) first TX antenna array. To generate a compensating EM-field it transmits the same data but applies special beamforming or weight vectors.

Two methods of calculating the compensating beamforming or weight vectors are provided. Method 1 may provide higher self-interference suppression, but it is applicable to a more limited set of the antenna configurations. Method 2 provides lower self-interference suppression, but it is applicable to a broader set of antenna configurations and requires less power for the suppressing array.

FIG. 11 shows schematically one example embodiment including three antenna arrays: the TX array, the RX array and the suppressing TX array, such as those set out above. This arrangement can be expanded for multiple frequency implementations The TX array and the suppressing TX array are connected to similar but separate analog RF blocks, which comprises a digital-to-analog converter (DAC), an RF filter (≈), a mixer (⊗), a local oscillator (LO), and a power amplifier (PA). Each analog RF block is connected to a digital frontend block, which comprises an inverse fast Fourier transform (iFFT), a cyclic prefix addition block (CP), a digital upconverter (DUC), a crest factor reduction block (CFR) and a digital predistortion block (DPD). In some implementations the DPD can be omitted from a suppressing digital frontend due to the low power radiated by the suppressing TX array.

Each baseband processing block has one additional functional block due to legacy implementation: beamforming vector for a single stream (or a beamforming matrix for multi-stream (such as single-user multiple input, multiple output (SU-MIMO) or multi-user multiple input, multiple output (MU-MIMO)) transformation block, denoted as w→W and w→Wₛ. Beamforming vector transformation blocks calculate beamforming or weight vectors W and Wₛ using Method 1 or Method 2, described below. Method 1 does not change w: W=w and therefore, if this method is used, w→W block can be omitted. The output of the beamforming vector transformation block is connected to the input of the beamforming block (BF), which is no different from the legacy implementation. Another input of BF block is a modulated data symbol s (s is scalar for a single stream and it is a data symbol vector for a multi-stream). It is the same in the TX chain and the suppressing TX chains. The rest of the blocks in the TX and suppressing TX baseband processing are no different from the legacy implementation and are not shown in FIG. 11.

It is assumed that the beamforming vector applied to the TX array changes as little as possible, or does not change it at all and that self-interference suppression is done by applying appropriate beamforming or weight vector to the suppressing array. Also, for ease of understanding, both methods are presented in their simplest form, ignoring noise.

Method 1 calculates the beamforming vector applied to the suppressing array without any modification of the beamforming vector applied to the TX array. Method 2 calculates the beamforming vector applied to the suppressing array and slightly modifies the beamforming vector applied to the TX array.

### Method 1

Method 1 calculates beamforming weights for the suppressing array according to equation (1):

$${W}_{S} = {C}_{S}^{- 1} {w}^{T} C \qquad ( 1 )$$

W_{S}∈ [symbol] is the beamforming vector applied to the suppressing array.

N_{S} is the number of antenna array elements of the suppressing array.

C_{S}∈ [symbol] is a covariance matrix of the channel between the suppressing array and the RX array.

w∈ [symbol] is the beamforming vector applied to the TX array.

N_{TX} is the number of antenna array elements of the TX array.

The covariance matrix C_{S} is given by equation (2):

$${C}_{S} = {{H}_{S} ( {H}_{S} )}^{H} \qquad ( 2 )$$

( . . . )^{H} denotes Hermitian transpose.
H_{S}∈ [symbol] is the channel matrix of the channel between the suppressing array and the RX array:

$${H}_{S} = [ \begin{matrix}{h}_{1 , 1}^{S} & ⋯ & {h}_{1 , {N}_{RX}}^{S} \\ ⋯ & ⋱ & ⋯ \\ {h}_{{N}_{s} , 1}^{S} & ⋯ & {h}_{{N}_{s} , {N}_{RX}}^{S}\end{matrix} ] \qquad ( 3 )$$

is the channel between the l-th antenna array element of the suppressing array and the m-th array antenna element of the RX array.
N_{RX} is the number of antenna array elements of the RX array.

The covariance matrix C is given by equation (4):

$$C = {H ( H )}^{H} \qquad ( 4 )$$

( . . . )^{H} denotes Hermitian transpose.
H∈ [symbol] is the channel matrix representing self-interference channel between the TX and the RX antenna arrays.

The matrix H is given by equation (5):

$$H = [ \begin{matrix}{h}_{1 , 1} & ⋯ & {h}_{1 , {N}_{RX}} \\ ⋯ & ⋱ & ⋯ \\ {h}_{{N}_{TX} , 1} & ⋯ & {h}_{{N}_{TX} , {N}_{RX}}\end{matrix} ] \qquad ( 5 )$$

h_{l,m}∈ [symbol] is the channel between the I-th antenna array element of the TX array and the m-th array antenna element of the RX array.

In another implementation the covariance matrices in equation (1) can be replaced by the channel matrices, see equation (6):

$${W}_{S} = {H}_{S}^{- 1} {w}^{T} H \qquad ( 6 )$$

### Method 2

Method 2 calculates the beamforming vector according to equation (7).

$${W}_{C} = {( 1 - {C}_{c} )}^{M} {w}_{C} \qquad ( 7 )$$

∈ [symbol] is a concatenation of two beamforming vectors: w and w_{S}:

$${w}_{C} = [ \begin{matrix}w \\ {w}_{S}\end{matrix} ] \qquad ( 8 )$$

w is a beamforming vector applied to the TX array and defined above, and w_{S} is a beamforming vector applied to the suppressing array. w_{S} can be initialized by a zero vector: w_{S}=0, or using equation (1).

W_{C} is a vector, obtained after transformation of w_{C}:

$${W}_{C} = [ \begin{matrix}W \\ {W}_{S}\end{matrix} ] \qquad ( 9 )$$

W_{S} is a transformed beamforming vector applied to the suppressing array.
W∈ [symbol] is transformed beamforming vector applied to the TX array.

$$M ∈ {N}_{1}^{1 \times 1}$$

is a power of the matrix polynomial and is a design parameter.

The covariance matrix C_{S}∈ [symbol] is given by equation (10):

$${C}_{C} = {{H}_{C} ( {H}_{C} )}^{H} \qquad ( 10 )$$

H_{C}∈ [symbol] is a concatenation of two matrices: H and H_{S}:

$${H}_{C} = [ \begin{matrix}H \\ {H}_{S}\end{matrix} ] \qquad ( 11 )$$

### Simulation Results

To evaluate the performance of the methods, the interference gain vectors I∈ [symbol] (equation (12)) and Iₛᵤₚ∈ [symbol] (equation (13)) were calculated. Each element of this vector is an interference gain value at one antenna array element of the RX array.

$$I = {( {H}_{C} )}^{T} {w}_{C} \qquad ( 12 )$$

$${I}_{sup} = {( {H}_{C} )}^{T} {W}_{C} \qquad ( 13 )$$

The performance of the methods was assessed using the interference gain power at the most affected antenna array element, calculated using equations (14) and (15).

$${I}^{m ax} = max {\vert I \vert}^{2} \qquad ( 14 )$$

$${I}_{sup}^{ma x} = max {\vert {I}_{sup} \vert}^{2} \qquad ( 15 )$$

Another criterium for performance evaluation is a squared L₂ norm of the difference of the beamforming vectors before and after transformation. Naturally, this norm is desired to be as small as possible. For legacy beam nulling, this norm is calculated according to equation (16) and for Method 1 and 2 according to equation (17).

$${‖ w - W ‖}^{2} \qquad ( 16 )$$

$${‖ {w}_{C} - {W}_{C} ‖}^{2} \qquad ( 17 )$$

w_{C} is defined according to equation (8). In equation (17), w_{S} in w_{C} is a zero vector, that is, a comparison is made with the case when the suppressing array is powered down. Another criterion for evaluating the proposed methods is the power ratio radiating by the suppressing array to the overall TX power. This ratio can be calculated according to equation (18).

$${‖ {W}_{S} ‖}^{2} / {‖ {W}_{C} ‖}^{2} \qquad ( 18 )$$

The interference power at the most affected antenna array element, the distortion of the transformed beamforming vector and the power ratio radiating by the suppressing array to the overall TX power depend on the beamforming vector w applied to the main TX antenna array. To take this into account simulations were done for 169 beamforming vectors providing different beam directions. FIG. 12 shows the azimuth and elevation angle corresponding to each beamforming vector in the set.

An antenna configuration with 16 cross-polarized antenna elements at the TX array and with the same number of antenna elements at the RX array were used in simulations. Each antenna array element is simulated as two orthogonal dipoles having a length 0.5λ, where λ is a wavelength. The distance between antenna array elements is 0.5λ in the horizontal and the vertical direction. The distance between TX and RX antenna arrays is equal to 4λ. Simulations were done with an Electro-Magnetic (EM)-simulator, using a method of moments (MoM) solver. An example of meshing, used by the MoM solver is shown on FIG. 13.

FIG. 14 illustrates a method according to one example embodiment. At step S10, the suppression signals and the transmit antenna array signals are generated as set out above. At step S20, the transmit antenna array signals are provided to the transmit antenna array which generates a transmission electromagnetic field and the suppression signals are provided to the suppression antenna array which generates a compensating electromagnetic field which reduces interference from said transmission electromagnetic field received by a receive antenna array.

FIG. 15 shows example deployments of the antenna configurations described above. In one example embodiment, a base station, such as a gNB 200 generates signals for the antenna array 210 which is deployed on a tower 220. In one example embodiment, the gNB 200 is coupled with the antenna array 210 via a remote radio head 230.

Some example embodiments provide for high suppression capability, low distortion of the beamforming vector (suitable for MU-MIMO) and are easier to implement than an analog RF suppression method but requires additional hardware.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods. The term non-transitory as used herein, is a limitation of the medium itself (i.e., tangible, not a signal) as opposed to a limitation on data storage persistency (e.g. RAM vs ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The ordering of method steps set out above may not be critical or fixed and the exact ordering of the steps may be varied as appropriate.

Although example embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

Further aspects and example embodiments will now be described.

An apparatus, comprising: a first antenna array comprising a plurality of first antenna array elements configured to transmit signals comprising encoded data in a first frequency band; a second antenna array comprising a plurality of second antenna array elements configured to receive signals comprising encoded data in the first frequency band; a third antenna array comprising a plurality of third antenna array elements; a suppression signal generator configured to generate first suppression drive signals in the first frequency band for the third antenna array elements to generate a compensating electromagnetic field to reduce interference received by the plurality of second antenna array elements in the first frequency band from the plurality of first antenna array elements; and a transceiver coupled with the third antenna array and configured to convey signals comprising encoded data in a second frequency band, wherein the second frequency band differs from the first frequency band.

The transceiver may be configured to receive signals comprising encoded data in the second frequency band from the third antenna array elements.

The transceiver may be configured to generate signals comprising encoded data in the second frequency band for the third antenna array elements.

The suppression signal generator may be configured to generate the first suppression drive signals in the first frequency band for the third antenna array elements concurrently with the transceiver conveying the signals in the second frequency band.

The transceiver may comprise a time-division-duplexer configured to time-division-duplex receiving the signals comprising encoded data in the second frequency band from the third antenna array elements with generating signals comprising encoded data in the second frequency band for the third antenna array elements.

The apparatus may comprise at least one of the following: a first wave trap; or a first electromagnetic shield configured to suppress interference signals in the first frequency band received by the plurality of second antenna array elements from the plurality of first antenna array elements.

The first wave trap or first electromagnetic shield may be positioned between the first antenna array and the third antenna array.

The third antenna array may be positioned between the first antenna array and the second antenna array.

The second antenna array and the third antenna array may be collocated.

The apparatus may comprise a fourth antenna array comprising a plurality of fourth antenna array elements configured to transmit signals comprising encoded data in the second frequency band.

The transceiver may be coupled with the fourth antenna array and may be configured to generate signals comprising encoded data in the second frequency band for the fourth antenna array elements.

The suppression signal generator may be configured to generate second suppression drive signals in the second frequency band for the second antenna array elements to generate a compensating electromagnetic field to reduce interference received by the plurality of third antenna array elements in the second frequency band from the plurality of fourth antenna array elements.

The second antenna array may be positioned between the fourth antenna array and the third antenna array.

The apparatus may comprise at least one of the following: a second wave trap; or second electromagnetic shield configured to suppress interference signals in the second frequency band received by the plurality of third antenna array elements from the plurality of fourth antenna array elements.

The second wave trap or second electromagnetic shield may be positioned between the second antenna array and the fourth antenna array.

The transceiver may be configured to convey signals comprising encoded data in the second frequency band and signals comprising encoded data in a third frequency band, wherein the third frequency band differs from the first frequency band and the second frequency band.

The transceiver may be configured to generate signals comprising encoded data in one of the first frequency band and the third frequency band for the third antenna array elements and to receive signals comprising encoded data in another of the second frequency band and the third frequency band comprising encoded data from the third antenna array elements.

The transceiver may be configured to generate the first suppression drive signals in the first frequency band from modulated data signals used to generate the signals comprising encoded data in the first frequency band.

The transceiver may be configured to generate the second suppression drive signals in the second frequency band from modulated data signals used to generate the signals comprising encoded data in the second frequency band.

The suppression signal generator may be configured to generate the first suppression drive signals by applying a first weight vector to the modulated data signals used to generate the signals comprising encoded data in the first frequency band.

The suppression signal generator may be configured to generate the second suppression drive signals by applying a second weight vector to the modulated data signals used to generate the signals comprising encoded data in the second frequency band.

The suppression signal generator may be configured to one of apply and not apply a modification to a first weight vector to the modulated data signals used to generate the signals comprising encoded data in the first frequency band.

The suppression signal generator may be configured to one of apply and not apply a modification to a second weight vector to the modulated data signals used to generate the signals comprising encoded data in the second frequency band.

The suppression signal generator may be configured to generate the first suppression drive signals based on at least one of the following: a matrix of a channel between the third antenna array and the second antenna array in the first frequency band and on a covariance matrix of a channel between the first antenna array and the second antenna array in the first frequency band and to calculate the first weight vector which, when applied to the third antenna array, causes the compensating electromagnetic field in the first frequency band, when superimposed with an electromagnetic field generated by the first antenna array, reduces self-interference at the second antenna array elements.

The suppression signal generator may be configured to generate the second suppression drive signals based on at least one of the following: a matrix of a channel between the second antenna array and the third antenna array in the second frequency band and on a covariance matrix of a channel between the fourth antenna array and the third antenna array in the second frequency band and to calculate the second weight vector which, when applied to the second antenna array, causes the compensating electromagnetic field, when superimposed with an electromagnetic field generated by the fourth antenna array, reduces self-interference at the third antenna array elements.

The suppression signal generator may be configured to generate the first suppression drive signals based on a matrix of a channel between the third antenna array and the second antenna array in the first frequency band and between the first antenna array and the second antenna array in the first frequency band.

The suppression signal generator may be configured to generate the first suppression drive signals based on a covariance matrix calculated from measurements of a channel between the third antenna array and the second antenna array in the first frequency band and between the first antenna array and the second antenna array in the first frequency band.

The suppression signal generator may be configured to generate the first suppression drive signals based on a covariance matrix calculated from of a matrix of a channel between the third antenna array and the second antenna array in the first frequency band and between the first antenna array and the second antenna array in the first frequency band and to calculate the first weight vector which, when applied partially to the third antenna array and partially to the first antenna array, causes the third antenna array to generate the compensating electromagnetic field in the first frequency band and the first antenna array to generate a transmit electromagnetic field in the first frequency band which, when superimposed, reduces self-interference at the second antenna array elements.

The suppression antenna signal generator may be configured to generate the second suppression drive signals based on a matrix of a channel between the second antenna array and the third antenna array in the second frequency band and between the fourth antenna array and the third antenna array in the second frequency band.

The suppression antenna signal generator may be configured to generate the second suppression drive signals based on a covariance matrix calculated from measurements of a channel between the second antenna array and the third receive antenna array in the second frequency band and between the fourth antenna array and the third antenna array in the second frequency band.

The suppression antenna signal generator may be configured to generate the second suppression drive signals based on a covariance matrix calculated from of a matrix of a channel between the second antenna array and the third antenna array in the second frequency band and between the fourth antenna array and the third antenna array in the second frequency band and to calculate the second weight vector which, when applied partially to the second antenna array and partially to the fourth antenna array, causes the second antenna array to generate the compensating electromagnetic field in the second frequency band and the fourth antenna array to generate a transmit electromagnetic field in the second frequency band which, when superimposed, reduces self-interference at the third antenna array elements.

The first suppression drive signals may have a lower power than drive signals provided to the plurality of first antenna array elements.

The second suppression drive signals may have a lower power than drive signals provided to the plurality of fourth antenna array elements.

The apparatus comprises a sub-band, non-overlapping, full-duplex antenna assembly.

The apparatus may be a network node device.

A method comprising: transmitting signals comprising encoded data in a first frequency band with a first antenna array comprising a plurality of first antenna array elements; receiving signals comprising encoded data in the first frequency band with a second antenna array comprising a plurality of second antenna array elements; generating first suppression drive signals in the first frequency band for a third antenna array comprising a plurality of third antenna array elements to generate a compensating electromagnetic field to reduce interference received by the plurality of second antenna array elements in the first frequency band from the plurality of first antenna array elements; and conveying signals comprising encoded data in a second frequency band with the third antenna array, wherein the second frequency band differs from the first frequency band.

The method may comprise receiving signals comprising encoded data in the second frequency band from the third antenna array elements.

The method may comprise generating signals comprising encoded data in the second frequency band for the third antenna array elements.

The method may comprise generating the first suppression drive signals in the first frequency band for the third antenna array elements concurrently with the conveying the signals in the second frequency band.

The method may comprise time-division-duplex receiving the signals comprising encoded data in the second frequency band from the third antenna array elements with generating signals comprising encoded data in the second frequency band for the third antenna array elements.

The method may comprise suppress interference signals in the first frequency band received by the plurality of second antenna array elements from the plurality of first antenna array elements with at least one of the following: a first wave trap; or a first electromagnetic shield.

The method may comprise positioning the first wave trap or first electromagnetic shield between the first antenna array and the third antenna array.

The method may comprise positioning the third antenna array between the first antenna array and the second antenna array.

The method may comprise collocating the second antenna array and the third antenna array.

The method may comprise transmitting signals comprising encoded data in the second frequency band with a fourth antenna array comprising a plurality of fourth antenna array elements.

The method may comprise generating signals comprising encoded data in the second frequency band for the fourth antenna array elements.

The method may comprise generating second suppression drive signals in the second frequency band for the second antenna array elements to generate a compensating electromagnetic field to reduce interference received by the plurality of third antenna array elements in the second frequency band from the plurality of fourth antenna array elements.

The method may comprise positioning the second antenna array may between the fourth antenna array and the third antenna array.

The method may comprise suppressing interference signals in the second frequency band received by the plurality of third antenna array elements from the plurality of fourth antenna array elements with at least one of the following: a second wave trap; or second electromagnetic shield.

The method may comprise positioning the second wave trap or second electromagnetic shield may between the second antenna array and the fourth antenna array.

The method may comprise conveying signals comprising encoded data in the second frequency band and signals comprising encoded data in a third frequency band, wherein the third frequency band differs from the first frequency band and the second frequency band.

The method may comprise generating signals comprising encoded data in one of the first frequency band and the third frequency band for the third antenna array elements and receiving signals comprising encoded data in another of the second frequency band and the third frequency band comprising encoded data from the third antenna array elements.

The method may comprise generating the first suppression drive signals in the first frequency band from modulated data signals used to generate the signals comprising encoded data in the first frequency band.

The method may comprise generating the second suppression drive signals in the second frequency band from modulated data signals used to generate the signals comprising encoded data in the second frequency band.

The method may comprise generating the first suppression drive signals by applying a first weight vector to the modulated data signals used to generate the signals comprising encoded data in the first frequency band.

The method may comprise generating the second suppression drive signals by applying a second weight vector to the modulated data signals used to generate the signals comprising encoded data in the second frequency band.

The method may comprise one of applying and not applying a modification to a first weight vector to the modulated data signals used to generate the signals comprising encoded data in the first frequency band.

The method may comprise one of applying and not applying a modification to a second weight vector to the modulated data signals used to generate the signals comprising encoded data in the second frequency band.

The method may comprise generating the first suppression drive signals based on at least one of the following: a matrix of a channel between the third antenna array and the second antenna array in the first frequency band and on a covariance matrix of a channel between the first antenna array and the second antenna array in the first frequency band and to calculate the first weight vector which, when applied to the third antenna array, causes the compensating electromagnetic field in the first frequency band, when superimposed with an electromagnetic field generated by the first antenna array, reduces self-interference at the second antenna array elements.

The method may comprise generating the second suppression drive signals based on at least one of the following: a matrix of a channel between the second antenna array and the third antenna array in the second frequency band and on a covariance matrix of a channel between the fourth antenna array and the third antenna array in the second frequency band and to calculate the second weight vector which, when applied to the second antenna array, causes the compensating electromagnetic field, when superimposed with an electromagnetic field generated by the fourth antenna array, reduces self-interference at the third antenna array elements.

The method may comprise generating the first suppression drive signals based on a matrix of a channel between the third antenna array and the second antenna array in the first frequency band and between the first antenna array and the second antenna array in the first frequency band.

The method may comprise generating the first suppression drive signals based on a covariance matrix calculated from measurements of a channel between the third antenna array and the second antenna array in the first frequency band and between the first antenna array and the second antenna array in the first frequency band.

The method may comprise generating the first suppression drive signals based on a covariance matrix calculated from of a matrix of a channel between the third antenna array and the second antenna array in the first frequency band and between the first antenna array and the second antenna array in the first frequency band and to calculate the first weight vector which, when applied partially to the third antenna array and partially to the first antenna array, causes the third antenna array to generate the compensating electromagnetic field in the first frequency band and the first antenna array to generate a transmit electromagnetic field in the first frequency band which, when superimposed, reduces self-interference at the second antenna array elements.

The method may comprise generating the second suppression drive signals based on a matrix of a channel between the second antenna array and the third antenna array in the second frequency band and between the fourth antenna array and the third antenna array in the second frequency band.

The method may comprise generating the second suppression drive signals based on a covariance matrix calculated from measurements of a channel between the second antenna array and the third receive antenna array in the second frequency band and between the fourth antenna array and the third antenna array in the second frequency band.

The method may comprise generating the second suppression drive signals based on a covariance matrix calculated from of a matrix of a channel between the second antenna array and the third antenna array in the second frequency band and between the fourth antenna array and the third antenna array in the second frequency band and to calculate the second weight vector which, when applied partially to the second antenna array and partially to the fourth antenna array, causes the second antenna array to generate the compensating electromagnetic field in the second frequency band and the fourth antenna array to generate a transmit electromagnetic field in the second frequency band which, when superimposed, reduces self-interference at the third antenna array elements.

The first suppression drive signals may have a lower power than drive signals provided to the plurality of first antenna array elements.

The second suppression drive signals may have a lower power than drive signals provided to the plurality of fourth antenna array elements.

The apparatus comprises a sub-band, non-overlapping, full-duplex antenna assembly.

The apparatus may be a network node device.

The method may comprise features corresponding to the features of the apparatus set out above.

A computer program comprising instructions stored thereon for performing at least the following: transmitting signals comprising encoded data in a first frequency band with a first antenna array comprising a plurality of first antenna array elements; receiving signals comprising encoded data in the first frequency band with a second antenna array comprising a plurality of second antenna array elements; generating first suppression drive signals in the first frequency band for a third antenna array comprising a plurality of third antenna array elements to generate a compensating electromagnetic field to reduce interference received by the plurality of second antenna array elements in the first frequency band from the plurality of first antenna array elements; and conveying signals comprising encoded data in a second frequency band with the third antenna array, wherein the second frequency band differs from the first frequency band.

The computer program may comprise features corresponding to the features of the method set out above.

A non-transitory computer readable medium comprising program instructions stored thereon for performing at least the following: transmitting signals comprising encoded data in a first frequency band with a first antenna array comprising a plurality of first antenna array elements; receiving signals comprising encoded data in the first frequency band with a second antenna array comprising a plurality of second antenna array elements; generating first suppression drive signals in the first frequency band for a third antenna array comprising a plurality of third antenna array elements to generate a compensating electromagnetic field to reduce interference received by the plurality of second antenna array elements in the first frequency band from the plurality of first antenna array elements; and conveying signals comprising encoded data in a second frequency band with the third antenna array, wherein the second frequency band differs from the first frequency band.

The non-transitory computer readable medium may comprise features corresponding to the features of the method set out above.

1. An apparatus, comprising:
a first antenna array comprising a plurality of first antenna array elements configured to transmit signals comprising encoded data in a first frequency band;
a second antenna array comprising a plurality of second antenna array elements configured to receive signals comprising encoded data in said first frequency band;
a third antenna array comprising a plurality of third antenna array elements;
a suppression signal generator configured to generate first suppression drive signals in said first frequency band for said third antenna array elements to generate a compensating electromagnetic field to reduce interference received by said plurality of second antenna array elements in said first frequency band from said plurality of first antenna array elements; and
a transceiver coupled with said third antenna array and configured to convey signals comprising encoded data in a second frequency band, wherein said second frequency band differs from said first frequency band.

2. The apparatus of claim 1, wherein said transceiver is configured to at least one of the following:
receive signals comprising encoded data in said second frequency band from said third antenna array elements; or
generate signals comprising encoded data in said second frequency band for said third antenna array elements.

3. The apparatus of claim 1, wherein said suppression signal generator is configured to generate said first suppression drive signals in said first frequency band for said third antenna array elements concurrently with said transceiver conveying said signals in said second frequency band.

4. The apparatus of claim 1, comprising at least one of the following: a first wave trap; or a first electromagnetic shield configured to suppress interference signals in said first frequency band received by said plurality of second antenna array elements from said plurality of first antenna array elements.

5. The apparatus of claim 1, wherein at least one of the following:
said first wave trap or first electromagnetic shield is positioned between said first antenna array and said third antenna array;
said third antenna array is positioned between said first antenna array and said second antenna array; or
said second antenna array and said third antenna array are collocated.

6. The apparatus of claim 1, comprising a fourth antenna array comprising a plurality of fourth antenna array elements configured to transmit signals comprising encoded data in said second frequency band.

7. The apparatus of claim 6, wherein said transceiver is coupled with said fourth antenna array and is configured to generate signals comprising encoded data in said second frequency band for said fourth antenna array elements.

8. The apparatus of claim 6, wherein said suppression signal generator is configured to generate second suppression drive signals in said second frequency band for said second antenna array elements to generate a compensating electromagnetic field to reduce interference received by said plurality of third antenna array elements in said second frequency band from said plurality of fourth antenna array elements.

9. The apparatus of claim 6, wherein said second antenna array is positioned between said fourth antenna array and said third antenna array.

10. The apparatus of claim 6, comprising at least one of the following: a second wave trap; or second electromagnetic shield configured to suppress interference signals in said second frequency band received by said plurality of third antenna array elements from said plurality of fourth antenna array elements.

11. The apparatus of claim 10, wherein said second wave trap or second electromagnetic shield is positioned between said second antenna array and said fourth antenna array.

12. The apparatus of claim 7, wherein said transceiver is configured to at least one of the following:
convey signals comprising encoded data in said second frequency band and signals comprising encoded data in a third frequency band, wherein said third frequency band differs from said first frequency band and said second frequency band;
generate signals comprising encoded data in one of said first frequency band and said third frequency band for said third antenna array elements and to receive signals comprising encoded data in another of said second frequency band and said third frequency band comprising encoded data from said third antenna array elements;
generate said first suppression drive signals in said first frequency band from modulated data signals used to generate said signals comprising encoded data in said first frequency band; or
generate said second suppression drive signals in said second frequency band from modulated data signals used to generate said signals comprising encoded data in said second frequency band.

13. The apparatus of claim 1, wherein said suppression signal generator is configured to at least one of the following:
generate said first suppression drive signals by applying a first weight vector to said modulated data signals used to generate said signals comprising encoded data in said first frequency band; or
generate said second suppression drive signals by applying a second weight vector to said modulated data signals used to generate said signals comprising encoded data in said second frequency band.

14. The apparatus of claim 1, wherein said suppression signal generator is configured to at least one of the following:
one of apply and not apply a modification to a first weight vector to said modulated data signals used to generate said signals comprising encoded data in said first frequency band; or
one of apply and not apply a modification to a second weight vector to said modulated data signals used to generate said signals comprising encoded data in said second frequency band.

15. The apparatus of claim 1, wherein said suppression signal generator is configured to generate said first suppression drive signals based on at least one of the following:
a matrix of a channel between said third antenna array and said second antenna array in said first frequency band and on a covariance matrix of a channel between said first antenna array and said second antenna array in said first frequency band and to calculate said first weight vector which, when applied to said third antenna array, causes said compensating electromagnetic field in said first frequency band, when superimposed with an electromagnetic field generated by the first antenna array, reduces self-interference at said second antenna array elements.
